(19) United States
(12) Patent Application Publication
(10) Pub. No.: US 2026/0233567 A1
(43) Pub. Date: Aug. 13, 2026

(54) ADDITIVE MANUFACTURED SUSPENSION COMPONENTS WITH AN INTEGRATED FLUID PASSAGE

(71) Applicant: Ford Global Technologies, LLC, Dearborn, MI (US)

(72) Inventors: David D. FRISKE, Wolverine Lake, MI (US); Keith WESTON, Canton, MI (US); Michael Joseph NIKSA, Royal Oak, MI (US)

(21) Appl. No.: 19/052,467

(22) Filed: Feb. 13, 2025

(51) Int. Cl. B60G 7/00; B29C 64/112; B29L 31/30; B33Y 10/00; B33Y 80/00; B60K 11/00; B60R 16/02; B60R 16/08; B60T 11/26; B62D 7/18

(52) U.S. Cl. CPC B60G 7/001; B29C 64/112; B33Y 10/00; B33Y 80/00; B60T 11/26; B62D 7/18; B29L 2031/30; B60G 2206/7101; B60G 2206/7102; B60G 2206/72; B60G 2206/82; B60K 11/00; B60R 16/0215; B60R 16/08

(57) ABSTRACT

A method for creating a suspension component of a suspension assembly of a vehicle may include forming a base portion of the suspension component via deposition of a material to partially form a structure having a first end and a second end, depositing additional material to form sides of a fluid channel inside the base portion between the first end and the second end, and enclosing the fluid channel and finishing the structure via deposition of the material to complete the suspension component.

### TECHNICAL FIELD

Example embodiments generally relate to suspension components and, more particularly, relate to a suspension component that allows for the integration of fluid passages within the body of the suspension component.

### BACKGROUND

Fluid lines or channels are crucial to numerous vehicle systems, including but not limited to the brake system and various cooling systems. For example, uninterrupted and efficient delivery of hydraulic fluid for the brake caliper or liquid coolant for an electric motor helps ensure expected vehicle braking performance. Typically, the fluid lines needed to deliver the necessary fluids to the vehicle systems must run through highly variable external positions of the vehicle (e.g. suspension assembly, wheel assembly, etc.) in the form of tubing.

To accommodate for variable external positions of the fluid lines, standard fluid lines incorporate additional slack or increase the thickness or material of the fluid passages to accommodate for the environment of the fluid passages. Thus, a fluid passage or fluid channel integrated within a suspension component to decrease the necessary length of the fluid lines and to shield the fluid passages from the environment would be desired.

### BRIEF SUMMARY OF SOME EXAMPLES

In accordance with an example embodiment, a method for creating a suspension component of a suspension assembly of a vehicle may be provided. The method may include forming a base portion of the suspension component via deposition of a material to partially form a structure having a first end and a second end, depositing additional material to form sides of a fluid channel inside the base portion between the first end and the second end, and enclosing the fluid channel and finishing the structure via deposition of the material to complete the suspension component.

In another example embodiment, a suspension component for a suspension assembly may be provided. The suspension component may include a base portion including a first end and a second end, and a fluid channel that may transfer a fluid from a fluid inlet to a fluid outlet. The fluid channel may be disposed between the first end and the second end, and the fluid channel may be formed and enclosed between manufacturing of the first end and manufacturing of the second end.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a suspension assembly for a vehicle in accordance with an example embodiment;

FIG. 2 illustrates a perspective view of the suspension component as a knuckle in accordance with an example embodiment;

FIG. 3 depicts a perspective view of the suspension component as a knuckle in accordance with an example embodiment;

FIG. 4 illustrates a cross-section view of the suspension component as a knuckle in accordance with an example embodiment;

FIG. 5 depicts a perspective view of a fluid channel in accordance with an example embodiment;

FIG. 6 illustrates a perspective view of a fluid inlet of the suspension component as a knuckle in accordance with an example embodiment;

FIG. 7 depicts a perspective view of a fluid outlet of the suspension component as a knuckle in accordance with an example embodiment;

FIG. 8A illustrates a perspective view of the suspension component as a knuckle in accordance with an example embodiment;

FIG. 8B illustrates a section view of the suspension component as a knuckle in accordance with an example embodiment;

FIG. 9 depicts a block diagram of the fluid channel with integrated accessories in accordance with an example embodiment;

FIG. 10 illustrates a printing assembly for a vehicle accessory in accordance with an example embodiment;

FIG. 11 depicts a perspective view of the suspension component as a control arm in accordance with an example embodiment;

FIG. 12 illustrates a perspective view of the suspension component as a control arm in accordance with an example embodiment;

FIG. 13 depicts a perspective view of the suspension component as a control arm in accordance with an example embodiment;

FIG. 14 illustrates a top view of the suspension component as a control arm in accordance with an example embodiment; and

FIG. 15 depicts a perspective view of the fluid channel in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about” and “substantially” should be understood to be definite approximations that account for variations in measurements that cannot be, or as one of skill in the art would appreciate, normally are not, measured precisely. Thus, for example, a parameter that is “about” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a suspension component with an integrated fluid passage to increase vehicle functionality. As a result, the fluid passage has increased protection and requires reduced material and yet is still able to provide fluid to remote components of the vehicle.

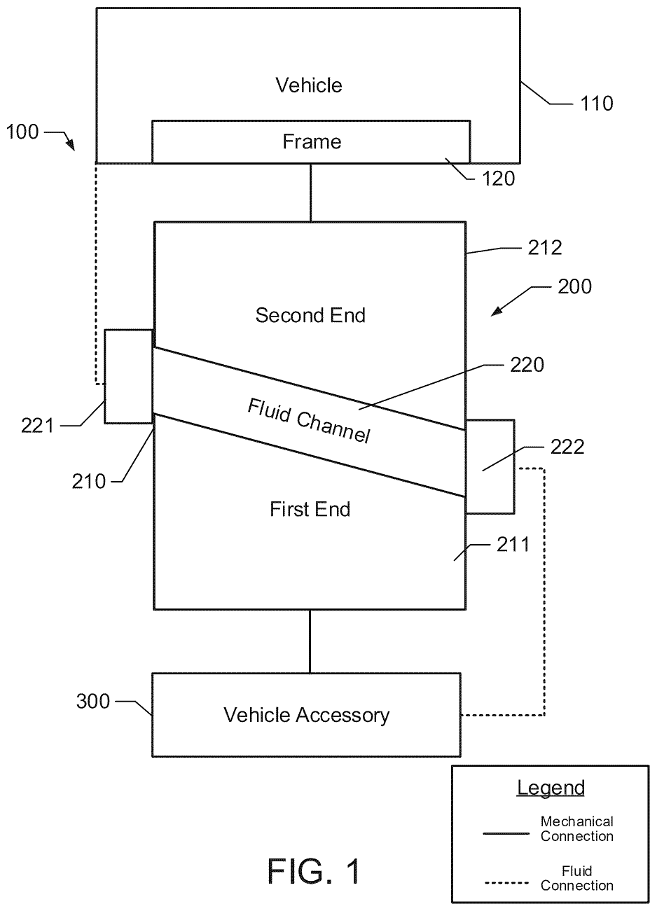

FIG. 1 illustrates a block diagram of a suspension component 200 of a suspension assembly 100 of a vehicle 110 in accordance with an example embodiment. In some cases, the vehicle 110 may include a chassis. In an example embodiment, the chassis may be a frame 120 or body of the vehicle 110. The chassis or frame 120 may support and/or may form the foundation structure of the vehicle 110. In some cases, the chassis and/or frame 120 may be formed of one or more casted or welded metal subframes or may be a unibody construction, and the suspension component 200 may be operably coupled to the chassis or frame 120 to help operably couple a vehicle accessory 300 to the vehicle 110.

The suspension component 200 may include, but is not limited to a control arm, a knuckle, a bushing, a suspension arm, or a suspension damper. In an example embodiment, the control arm may include a rear control arm or a front control arm. Multiple instances of the suspension component 200 may be included within the vehicle 110. For example, both a control arm and a knuckle may be operably coupled to one another within the vehicle 110.

In some cases, the suspension component 200 may include a base portion 210 with a first end 211 and a second end 212. The base portion 210 may be the body of the suspension component 200 and may define the majority of physical bulk of the suspension component 200. In an example embodiment, the first end 211 may be the lower end of the suspension component 200, and the second end 212 may be the upper end of the suspension component 200. The upper end of the suspension component 200 may be the end of the suspension component 200 proximate to the frame 120 of the vehicle 110, and the lower end of the suspension component 200 may be the end of the suspension component 200 proximate to the driving surface or surface traveled by the vehicle 110. However, lateral positioning where neither the first end 211 nor the second end 212 is closer to the driving surface is also possible.

In an example embodiment, the suspension component 200 may include a fluid channel 220. The fluid channel 220 may also include, but is not limited to a fluid reservoir, a fluid passageway, a fluid line, or a fluid conduit. The fluid channel 220 may be disposed and/or integrated within the base portion 210. The same material may form both the base portion 210 and the fluid channel 220. Thus, the fluid channel 220 should be understood to be defined by walls or surfaces that define a void that is formed within the bounds that the fluid channel 220 defines for carrying the fluid. In some cases, load-carrying materials may form the base portion 210 and the fluid channel 220. Load-carrying materials may be materials that include sufficient strength to withstand the forces experienced by the suspension component 200. For example, the load-carrying material may include but is not limited to aluminum, steel, carbon fiber, and composite materials. In an example embodiment, different materials may form the base portion 210 and the fluid channel 220. For example, while the load-carrying material may form the base portion 210, a sturdy plastic or polymer may form the fluid channel 220.

In some cases, the fluid channel 220 may separate the first end 211 and the second end 212. For example, the fluid channel 220 may separate or bisect the base portion 210 to form the first end 211 and the second end 212. The fluid channel 220 may include a fluid inlet 221 and a fluid outlet 222. In an example embodiment, the fluid inlet 221 may be disposed on the upper half (proximate the frame 120) of the suspension component 200, and the fluid outlet may be disposed on the lower half (proximate the driving surface) of the suspension component 200. The fluid inlet 221 may receive a fluid from a different area of the vehicle and begin redirecting the fluid through the fluid channel 220 within the suspension component 200. The fluid outlet 222 may then receive the fluid from the fluid channel 220 and begin redirecting the fluid to the vehicle accessory 300.

In some examples, the fluid inlet 221 and/or fluid outlet 222 may protrude from the suspension component 220 to essentially extend the fluid channel 220. In such cases, an external fluid line (e.g., a tube, hose or other fluid line) may interface with the protruding part of the fluid inlet 221 and/or fluid outlet 222. For example, the tube or hose may slide over or inside the protruding part of the fluid inlet 221 and/or fluid outlet 222 to define an interference fit or other tight coupling to make a leak free interface with between the fluid inlet 221 and/or fluid outlet 222 and the tube or hose. However, rather than protruding, the fluid inlet 221 and/or fluid outlet 222 may alternatively be recessed and receive the hose or tube of the fluid line that interfaces therewith inside the recessed part via a tight and leak free coupling.

In still other alternatives, the fluid inlet 221 of one instance of the suspension component 200 may interface with the fluid outlet 222 of an adjacent instance of the suspension component 200. Thus, for example, two (or more) consecutive fluid channels 220 may be operably coupled directly to each other in two adjacent instances of the suspension component 200. This may eliminate the need for tubing or hoses between components.

In an example embodiment, the vehicle accessory 300 may include a wide variety of different vehicle accessories or different vehicle assemblies for different locations of the vehicle 110. For example, in some cases, the vehicle accessory 300 may be a wheel assembly, a brake assembly, or a motor. The vehicle accessory 300 may not be limited to the aforementioned list of accessory types, and may be any number of accessory types that integrate with and/or operably couple with the vehicle 110. In some cases, the vehicle 110 may include multiple instances of the vehicle accessory 300. The multiple instances of the vehicle accessory 300 may include multiple instances of the same type of vehicle accessory 300 or may include a variety of different types of the vehicle accessory 300.

The vehicle accessory 300 may operably couple both mechanically and/or fluidly to the suspension component 200. For example, if the vehicle accessory 300 is a brake assembly and the suspension component 200 is a knuckle, the brake assembly may operably couple to the knuckle mechanically via a mechanical fastener (e.g. nut, bolt, screw, etc.) and fluidly via tubing extending from the fluid outlet 222 to a different fluid inlet disposed on the brake assembly.

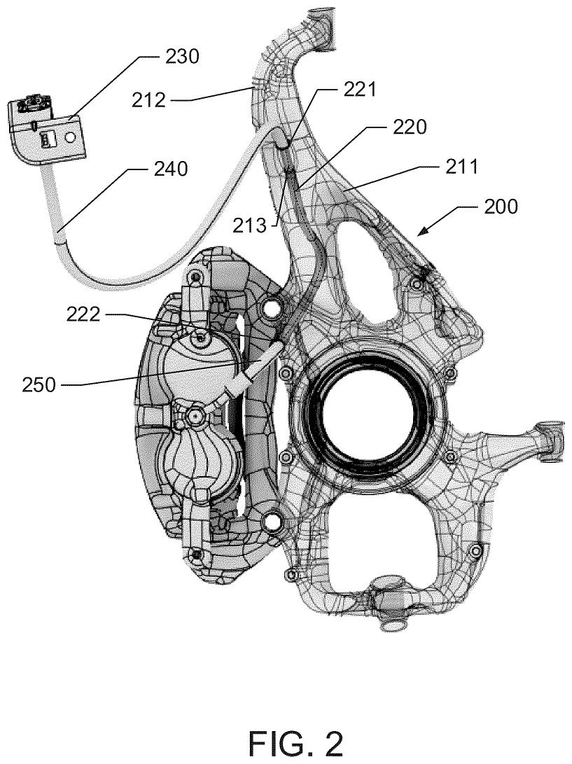

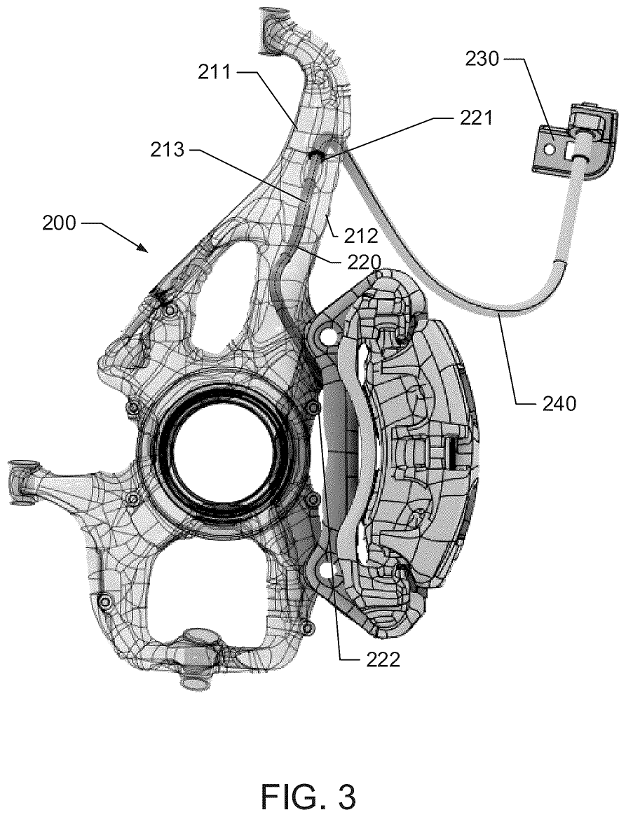

FIGS. 2 and 3 depict perspective views of the suspension component with the vehicle accessory. In some cases, as seen in FIGS. 2 and 3, the suspension component 200 may be a knuckle, and the vehicle accessory 300 may be a brake assembly. In this regard, the fluid channel 220 may transfer a hydraulic fluid, and the brake assembly may be a hydraulic brake assembly. The combination of the knuckle and brake assembly may be present at each instance of a wheel assembly of the vehicle 110. In an example embodiment, the fluid channel 220 integrate within the base portion 210 of the knuckle. In FIGS. 2 and 3, the base portion 210 is depicted as translucent to best highlight the fluid channel 220. A fluid channel midline 213 through the middle of the fluid channel 220 is also depicted. The fluid channel midline 213 may separate the first end 211 and the second end 212. In some cases, a fluid connector 230 may operably couple the suspension component 200 and the fluid channel 220 to the fluid system of the vehicle 110. The fluid system may include a fluid reservoir or fluid pump in addition to the fluid channel 220 within the suspension component 200. For example, if hydraulic fluid is being transferred, the fluid system may include a hydraulic fluid pump and a hydraulic fluid reservoir operably coupled to each instance of the suspension component 200 and the brake assembly throughout the vehicle 110.

In an example embodiment, the fluid connector 230 may operably couple fluid system tubing to the suspension component fluid tubing 240. The suspension component fluid tubing 240 may further operably couple with the fluid inlet 221 of the suspension component 200 to transfer the fluid to the fluid channel 220. A vehicle accessory fluid tubing 250 additionally may operably couple to the fluid outlet 222 of the suspension component 200 to transfer the hydraulic fluid within the fluid channel 220 to the vehicle accessory 300. In this regard, the brake assembly may receive hydraulic fluid without needing to route additional hydraulic tubing around the entire length of the knuckle. Thus, as the knuckle may move as much as 15 inches during a suspension event, minimal force may be exerted on the hydraulic fluid tubing throughout the suspension component 200 and the vehicle accessory 300. Additionally, a portion of the hydraulic fluid tubing that typically may be external to the vehicle may be replaced by the fluid channel 220 and thus be protected within the suspension component 200. In this regard, the fluid channel 220 exposes less of the fluid system to the environment compared to a complete hydraulic fluid tubing fluid system.

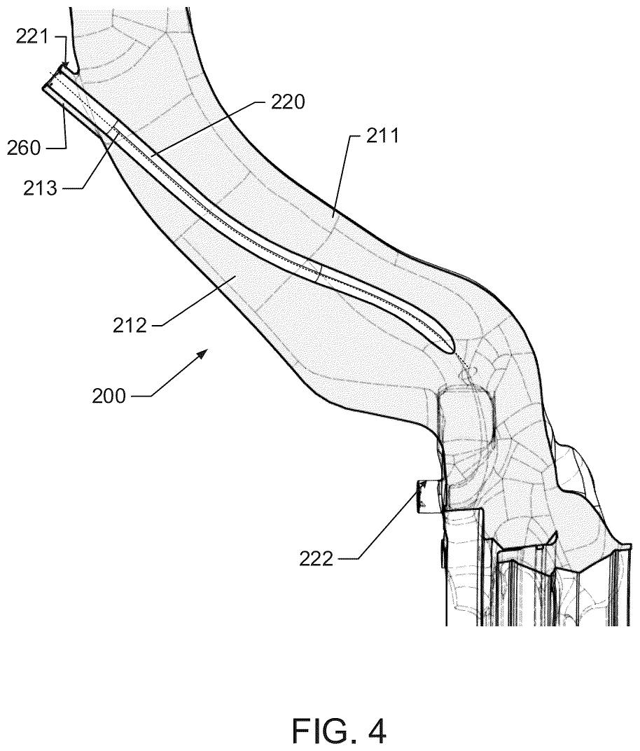

FIG. 4 depicts a section view of the suspension component 200 of FIGS. 2 and 3. In some cases, as seen in FIG. 4, the fluid channel 220 may not be directly centered within the suspension component 200. The manufacturing process may optimize the positioning of the fluid channel 220 to ensure the “shortest run” through the suspension component 200. In some cases, the “shortest run” may not be the absolute minimum length of the fluid channel 220 to traverse the suspension component 200 from fluid inlet 221 to fluid outlet 222, but instead may be the minimum length of the fluid channel 220 to maintain optimal fluid dynamics and performance metrics. For example, the absolute minimum length of the fluid channel 220 may decrease fluid flow rate compared to the “shortest run” and may be too close to the outer edge of the suspension component 200 to maintain ideal performance metrics (e.g. apply too much pressure to suspension component 200 without necessary depth within the suspension component 200).

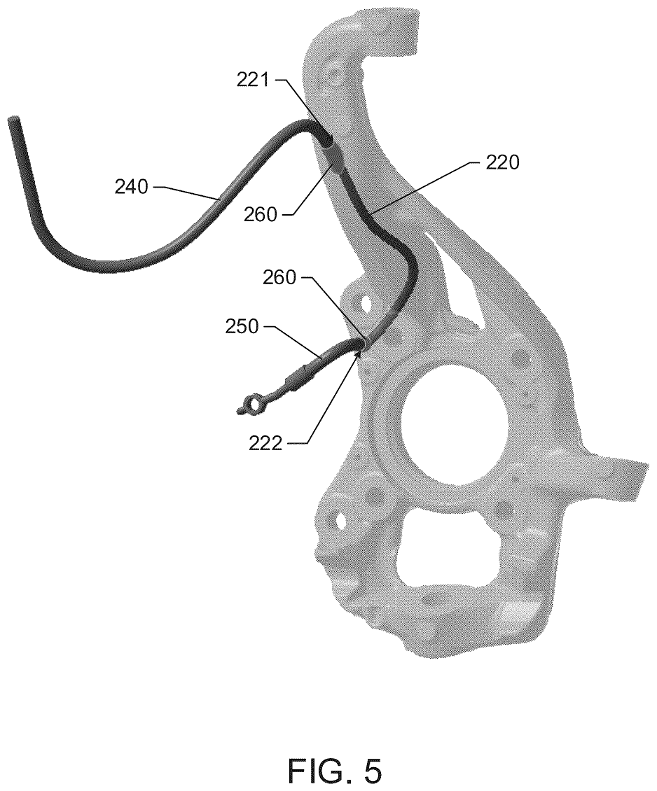

FIG. 5 depicts a perspective view of the suspension component 200 as a knuckle, and FIG. 5 may further highlight necessary constraints of the pathing of the fluid channel 220. As seen in FIG. 5, the fluid channel 220 may limit sharp angle turns and close proximity to the edge of the suspension component 200. In some cases, the positions of the fluid inlet 221 and the fluid outlet 222 may take into account the “shortest run” of the fluid channel 220, and they may be disposed to limit interaction with other fasteners and orifices within the suspension component 200.

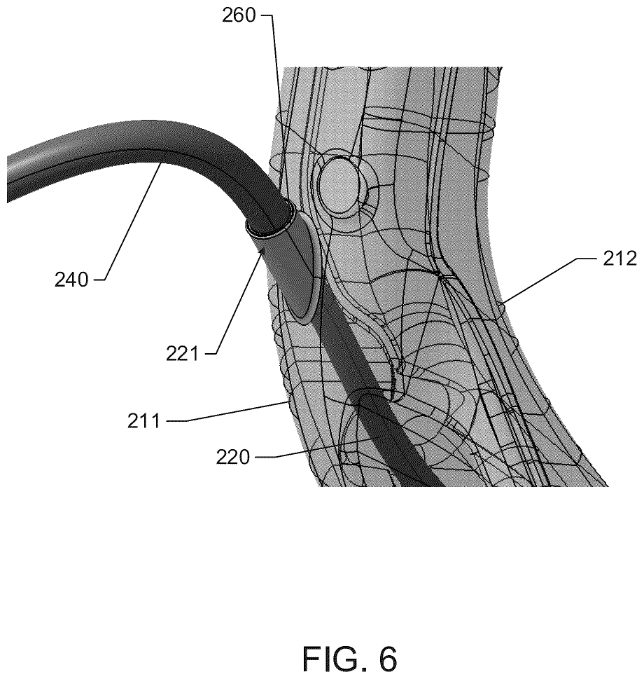

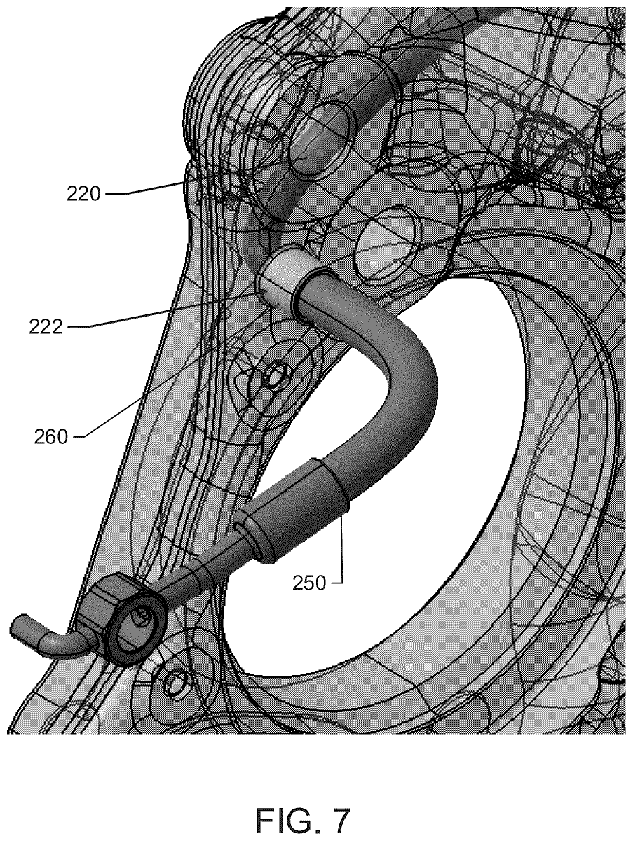

FIGS. 6 and 7 illustrate closer views of the fluid inlet and fluid outlet respectively of the suspension component of FIGS. 2-5. As seen in FIGS. 6 and 7, as well as FIGS. 4 and 5, the fluid inlet 221 and the fluid outlet 222 may have a coupling member 260 extending outwards from the fluid channel 220 and away from the suspension component 200.

The coupling member 260 may help operably couple the suspension component fluid tubing 240 and the vehicle accessory fluid tubing 250 to the fluid channel 220. In some cases, the coupling member 260 may be integral with or directly form the fluid inlet 221 and fluid outlet 222. The coupling member 260 may extend into the fluid channel 220 and overlap with a portion of the fluid channel 220. The overlap of the fluid channel 220 and the coupling member 260 may help ensure fluid stability when the fluid transitions between the suspension component fluid tubing 240, fluid channel 220, and the vehicle accessory fluid tubing 250.

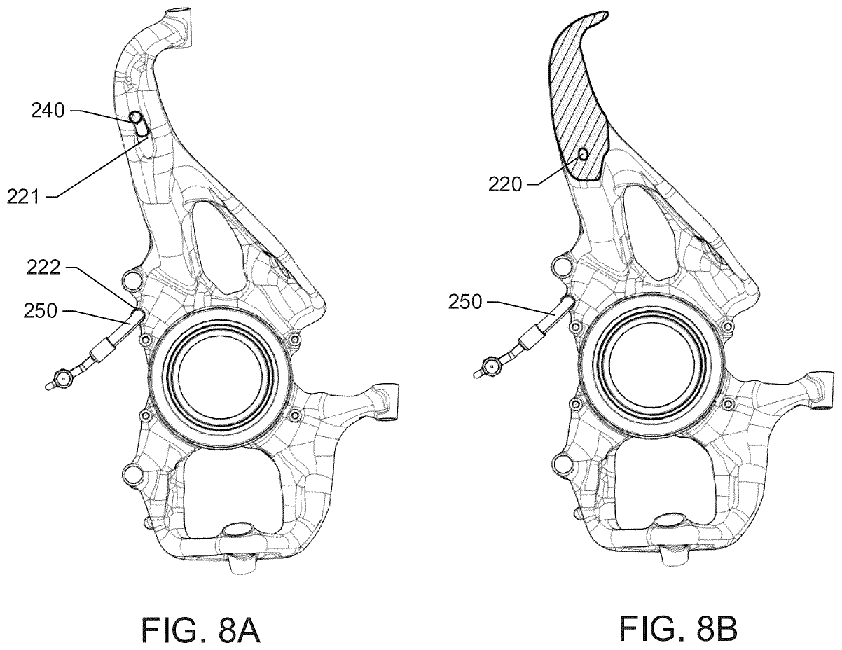

FIGS. 8A and 8B depict a perspective view and a section view respectively of the suspension component as a knuckle. In some cases, FIG. 8B may be a 50 mm section cut of 8A. FIGS. 8A and 8B may further highlight the positioning of the fluid channel 220 respective the suspension component 200.

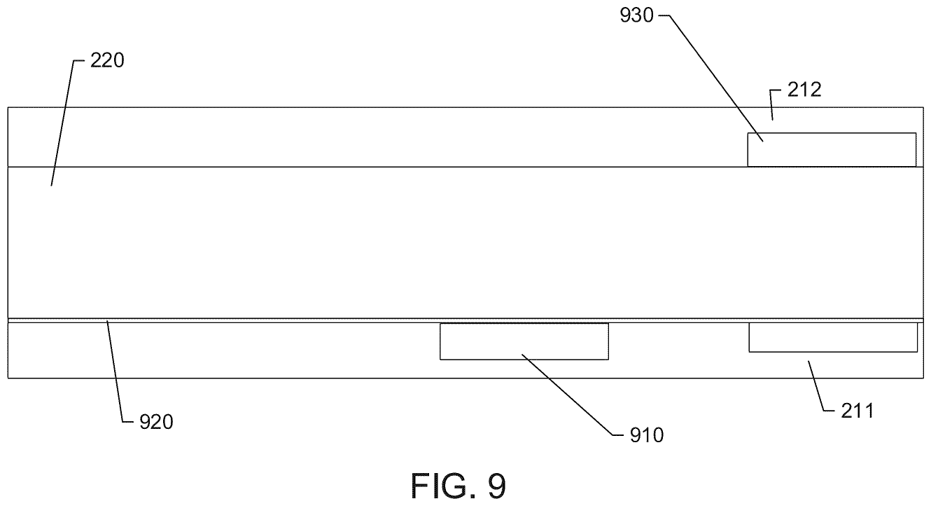

FIG. 9 illustrates a block diagram of a fluid channel with the integration of additional accessories. The manufacturing process may integrate a variety of accessories within the suspension component 200 along with the fluid channel 220. In an example embodiment, the manufacturing process may integrate a sensor 910 within the suspension component 200 or the fluid channel 220. In some cases, the sensor 910 may be a plurality of sensors. The sensor 910 may measure telemetry or environmental data of the suspension component 200. For example, the sensor 910 may be a strain gauge. The strain gauge may measure stress and forces exerted on the suspension component 200 throughout various suspension events of the vehicle 110. Additionally, the strain gauge may communicate and transmit its telemetry data to a controller or control module of the vehicle 110. Responsive to receiving the telemetry data, the controller or the control module may modify the suspension system (e.g. if the suspension system includes active suspension elements, adjusting damping coefficients of hydraulic dampers).

In an example embodiment, the accessories may also include electrical wiring 920. The electrical wiring 920 may integrate internally to the suspension component 200 or on a wall of the fluid channel 220. The electrical wiring 920 may operably couple to the sensor 910 also integrated within the suspension component 200. In some cases, the electrical wiring 920 may extend along the length of the fluid channel 220 and the suspension component 200, and the electrical wiring may be substantially parallel with the fluid channel 220. An insulator may additionally surround the electrical wiring 920 may during integration within the suspension component 200 during the manufacturing process.

In some cases, the accessory may be a bushing 930 integrated within the suspension component 200 and/or fluid channel 220. The fluid channel 220 may integrate within the bushing 930, as well as the suspension component 200. For example, the bushing 930 may be a hydraulic bushing and the fluid channel 220 may pass and direct hydraulic fluid through the bushing 930 to change its damping coefficient. In an example embodiment, the fluid channel 220 may partially divert or split to pass through the length of the suspension component 200, as well as the bushing 930.

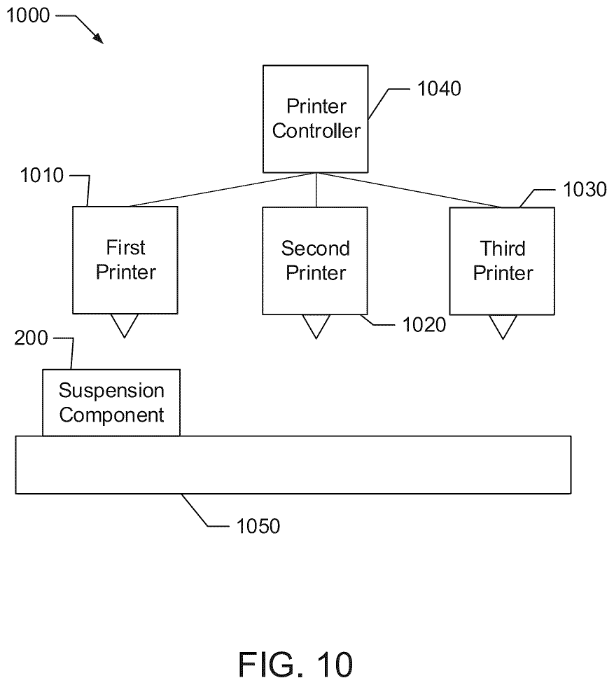

FIG. 10 illustrates an additive manufacturing system for manufacturing the suspension component 200. In an example embodiment, an additive manufacturing system 1000 or method may manufacture or form the suspension component 200. The additive manufacturing system 1000 may include one or more printers that may deposit material to form the suspension component 200. The one or more printers may include 3D printers. In some cases, the one or more printers may deposit load carrying materials to form the suspension component 200. Load carrying materials may include but are not limited to aluminum, steel, carbon fiber, and composite materials, as long as the material maintains the performance standards of the suspension component 200.

In an example embodiment, the one or more printer may include an ink-jet printer and/or additional 3D printers. The one or more printers may be individual pieces of a larger, single printer. For example, a larger, single printer may include multiple different nozzles to integrate the functionality of multiple printers (e.g. ink-jet printer and 3D printer). The one or more printers may also be operably coupled to and operated via a printer controller 1040.

In an example embodiment, the printer controller 1040 may be a controller. In some cases, the printer controller 1040 may include one or more control modules (i.e., sub-control modules or operably coupled to other control modules). The printer controller 1040 may include processing circuitry that includes a processor and memory. The processing circuitry may be configured to provide electronic control of the inputs to one or more functional units of the additive manufacturing system 1000 and to process data received at or generated by the one or more functional units of the additive manufacturing system 1000. Thus, the processing circuitry may be configured to perform data processing, control function execution and/or other processing and management services according to an example embodiment. In some embodiments, the processing circuitry may be embodied as a semiconductor chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. The printer controller 1040 of the additive manufacturing system 1000 may receive instructions and designs to modify the construction of the suspension component 200 based on previous manufacturing cases.

In an example embodiment, the printer controller 1040 may control a first printer 1010, a second printer 1020, and a third printer 1030. To create and manufacture the suspension component 200, the first printer 1010 may initially form the first end 211 of the base portion 210 of the suspension component 200. The first printer 1010 may be a 3D printer and deposit the load-carrying material to form the first end 211. In some cases, after the first printer 1010 finishes the formation of the first end 211, a moving apparatus 1050 may move the suspension component 200 from the first printer 1010 to the second printer 1020, third printer 1030, and vice versa. The moving apparatus 1050 may be a conveyer system or other device/system that may move the suspension component 200 throughout its production process.

In some cases, the second printer 1020 may then form the fluid channel 220 of the suspension component 200. The second printer 1020 may deposit additional material to form the sides of the fluid channel 220 inside the base portion 210 of the suspension component 200. In an example embodiment, the second printer 1020 may also integrate any accessories within the suspension component 200 and/or the fluid channel 220. For example, the second printer 1020 may add the sensor 910 and/or the electrical wiring 920 in parallel with forming the sides of the fluid channel 220. The second printer 1020 may not always add the accessories and/or the fluid channel 220, but the third printer 1030 or other additional printers or manufacturing techniques may add the accessories and/or the fluid channel 220 instead.

In some cases, an ink jet printer may integrate accessories by applying conductive ink. The conductive ink may be a liquid-based ink. With conductive ink printing, a computer-aided design (CAD) representation of circuitry or electronics may be directly incorporated during or after the primary manufacturing or assembly process of a part of the base portion 210 without losing specificity. Conductive ink printing may include conductive inks composed with conductive metal fillers and polymer resins. The conductive metal fillers may provide desired electrical and thermal properties. For example, the conductive metal filler may be silver, as the conductive ink needs to be easily liquefied at relatively low temperatures (i.e. 500° F. or less), while maintaining its conductivity through the printing process and application. In some cases, the temperature threshold may be higher (i.e. 2000° F. or less) depending on the application. The polymer resins may provide mechanical strength and flexibility in application of the conductive ink printing. For example, silver nitrate may be a commonly used ink for conductive ink printing. Forming accessories via conductive ink printing may allow for increased flexibility of manufacturing of the suspension component 200 and fluid channel 220. Conductive ink printing may also be conductive ink painting.

After formation of the sides of the fluid channel 220 and/or the integration of any desired accessories, the moving apparatus 1050 may transfer the base portion 210 from the second printer 1020 back to the first printer 1010 and/or to the third printer 1030 to enclose the fluid channel 220 by depositing material to finish the suspension component 200 via forming the second end 212. During the formation of the second end 212, additional accessories may be added to the suspension component 200 if desired. In some cases, the first end 211 and the second end 212 may be formed of the same load carrying material. A load carrying material may also form the fluid channel 220. The load carrying material of the fluid channel 220 may be the same material as the first end 211 and/or the second end 212 or may be a different load carrying material optimized for fluid transfer.

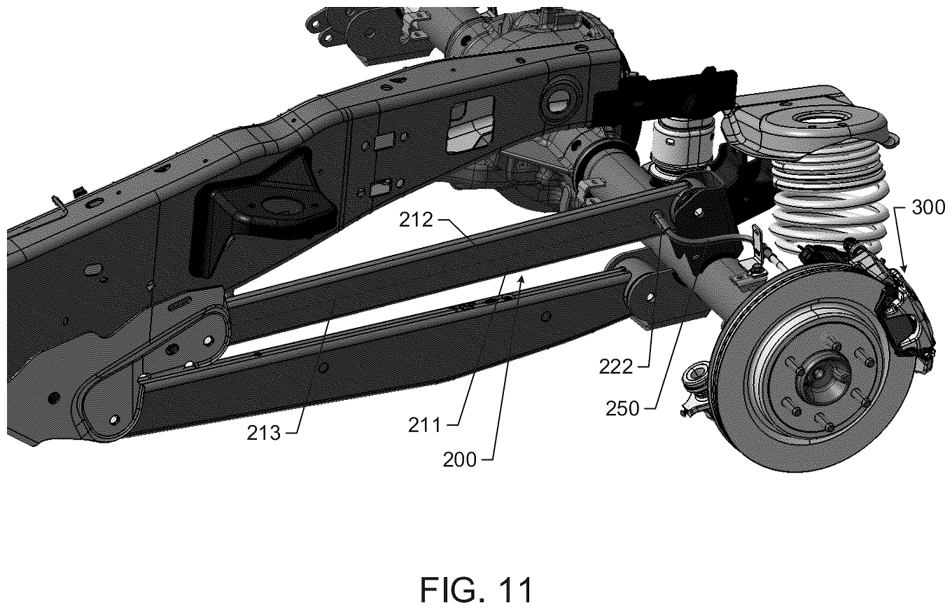

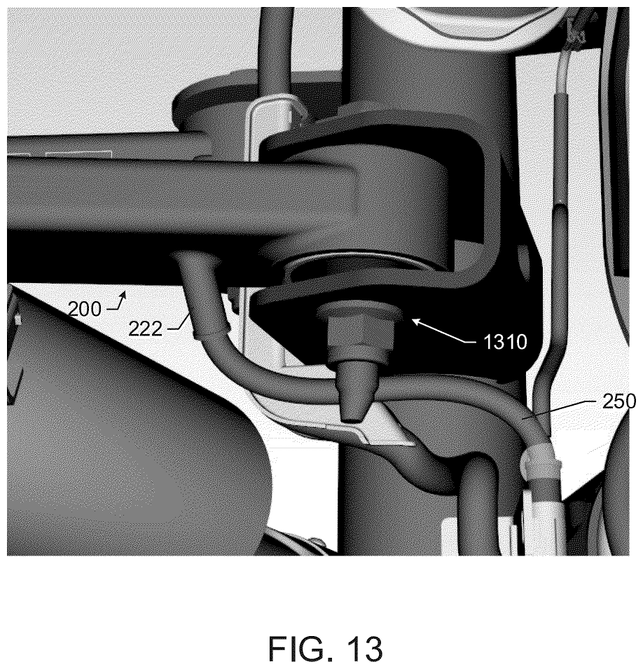

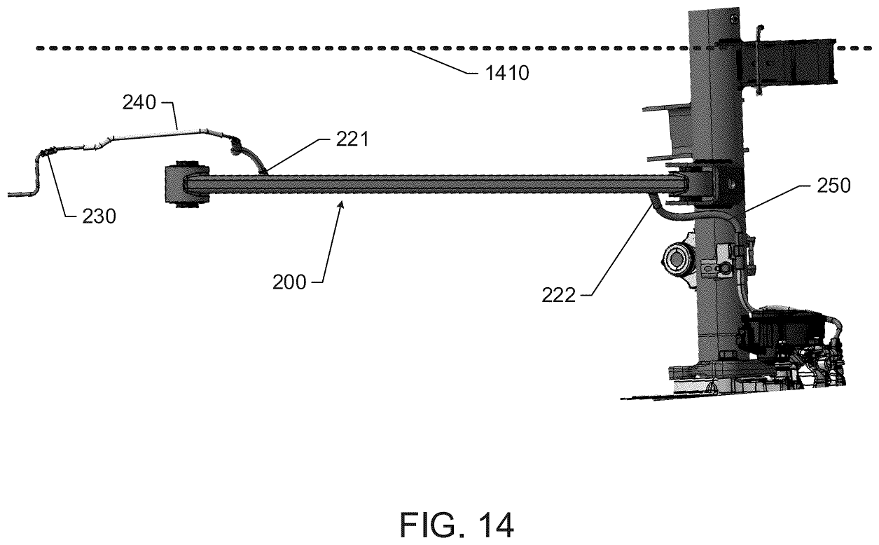

FIGS. 11-14 depict perspective views of the suspension component as a control arm in accordance with an example embodiment. In some cases, the suspension component 200 may be an upper control arm or a lower control arm. Upon integration of the fluid channel 220 within the control arm, the routing of fluid from the main reservoirs of the vehicle 110 to the rear of the vehicle 110 may have less exposure to the environment. In this regard, the fluid lines and/or channels of the vehicle 110 may limit stone pecking and other environmental influences of the position of the suspension component 200.

Similar to the example embodiment of the suspension component 200 as a knuckle, the suspension component 200 as a control arm may include a fluid inlet 221 and a fluid outlet 222. In some cases, the fluid inlet 221 may be disposed on closer to the longitudinal centerline 1410 of the vehicle 110 than the fluid outlet 222. Conversely, the fluid outlet 222 may be disposed closer to the vehicle accessory 300 than the fluid inlet 221.

The control arm embodiment may also include the fluid connector 230. The fluid connector 230 may operably couple directly to the frame 120 of the vehicle 110. In an example embodiment, the fluid connector 230 and frame 120 may operably couple via a fastener or clip 1210 operably coupled to the frame 120. The fluid connector 230 may route around the frame 120 to an additional clip 1210 to ensure fluid system stability throughout its length. In some cases, the vehicle accessory fluid tubing 250 may route around and between the mounting features 1310 of the control arm to increase fluid system stability.

In an example embodiment, the fluid channel 220 within the control arm may help transfer hydraulic fluid to a brake assembly or may help transfer coolant to the vehicle accessory 300 (e.g. electric motor) disposed proximate the fluid outlet 222. The coolant may ensure the operating temperature of an electric motor or the brake assembly maintains within a performance range for optimal operation. The coolant may include but is not limited to water, a glycol composite, or oils.

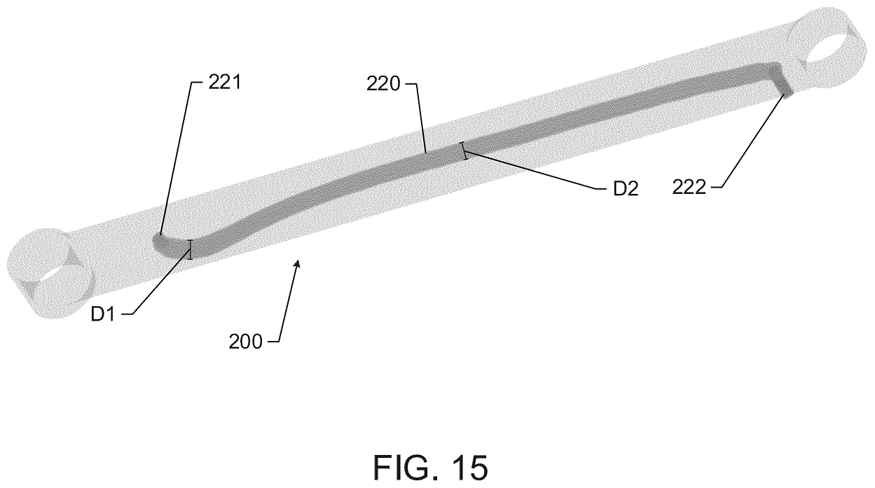

Depending on the type of fluid intended for the fluid channel 220 to transfer, the geometry of the fluid channel 220 may change. For example, different fluid types may include different fluid properties, which exert vastly different forces on the fluid channel 220 or have vastly different flow rates/viscosities to affect fluid transit time between the fluid inlet 221 and the fluid outlet 222. In an example embodiment, the fluid channel 220 may include a variable diameter (see larger diameter D1 and smaller diameter D2 in FIG. 15) along its length. The variable diameter may allow for accumulation of additional fluid within the base portion 210, which may provide a buffer to minimize pressure waves. The accumulation of additional fluid within the base portion 210 may limit the accumulation of additional fluid at the vehicle accessory 300.

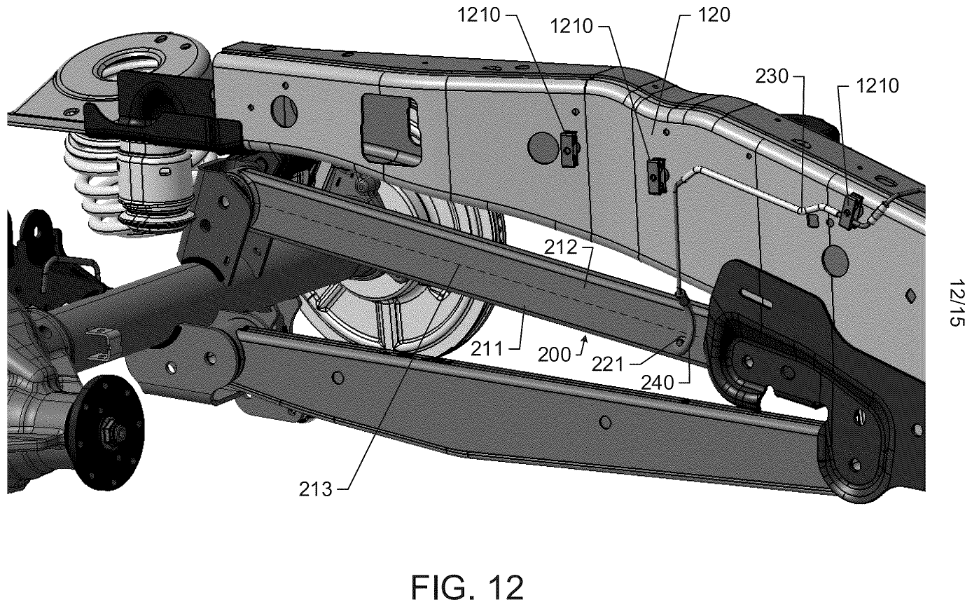

Additionally, in some cases, the geometry of the fluid channel 220 may change based on the type of the vehicle accessory 300. In an example embodiment, if the vehicle accessory 300 is a brake assembly, the fluid channel 220 may include a brake bleed. In this regard, the brake bleed may be disposed at the lower portion of the suspension component 200 to limit brake fluid from dirtying the brake calipers. The type of vehicle accessory 300 may also modify the stiffness of the suspension component fluid tubing 240 and the vehicle accessory fluid tubing 250. For example, brake line may require high stiffness and thus the fluid outlet 222 may be disposed as proximate as possible to the vehicle accessory 300 so that the vehicle accessory fluid tubing 250 has the minimum length and thus an increased stiffness. The routing of the vehicle accessory fluid tubing 250 may also affect the stiffness. In an example embodiment, as seen in FIG. 12, the geometry of the fluid outlet 222 and the vehicle accessory 300 may route the vehicle accessory fluid tubing 250 under and against the mounting features 1310 to provide increased stability and thus increased stiffness to the vehicle accessory fluid tubing 250.

A method for creating a suspension component of a suspension assembly of a vehicle may therefore be provided. The method may include forming a base portion of the suspension component via deposition of a material to partially form a structure having a first end and a second end, depositing additional material to form sides of a fluid channel inside the base portion between the first end and the second end, and enclosing the fluid channel and finishing the structure via deposition of the material to complete the suspension component.

The method for creating a suspension component of some embodiments may include additional features, modifications, augmentations and/or the like to achieve further objectives or enhance performance of vehicle systems. The additional features, modifications, augmentations and/or the like may be added in any combination with each other. Below is a list of various additional features, modifications, and augmentations that can each be added individually or in any combination with each other. For example, the method may include that the suspension component may be a knuckle, and the fluid channel may be a hydraulic fluid line that transfers hydraulic fluid to a component of a brake assembly. In some cases, the suspension component may be a control arm, and the fluid channel may be a hydraulic fluid reservoir that holds hydraulic fluid for use by a brake assembly. In an example embodiment, the fluid channel may be a coolant fluid line delivering a coolant fluid through the suspension component to additional components of the vehicle. In some cases, the material and the additional material may be load carrying materials, and the load carrying material may be aluminum, steel, carbon fiber, and composite materials. In an example embodiment, the method may further include integrating one or more accessories along with the depositing of the additional material to form the fluid channel. In some cases, the one or more accessories may include electrical wiring surrounded by an insulator. In an example embodiment, the one or more accessories may include one or more sensors to measure telemetry or environmental data of the suspension component. In some cases, the one or more accessories may include a hydraulic bushing, the hydraulic bushing may include the fluid channel, and a damping coefficient of the hydraulic bushing may change responsive to hydraulic fluid passing through the fluid channel. In an example embodiment, the fluid channel may include a variable diameter, and the variable diameter may allow for accumulation of additional fluid within the base portion. In some cases, positioning of the fluid channel within the suspension component may be based on a shortest run length through the suspension component that maintains structural properties of the suspension component. In an example embodiment, the method may be performed with an additive manufacturing technique utilizing multiple nozzles for different material types or various stages of the method.

A suspension component for a suspension assembly of an example embodiment may be provided. The suspension component may include a base portion including a first end and a second end, and a fluid channel that may transfer a fluid from a fluid inlet to a fluid outlet. The fluid channel may be disposed between the first end and the second end, and the fluid channel may be formed and enclosed between manufacturing of the first end and manufacturing of the second end.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A method for creating a suspension component of a suspension assembly of a vehicle, the method comprising:
forming a base portion of the suspension component via deposition of a material to partially form a structure having a first end and a second end;
depositing additional material to form sides of a fluid channel inside the base portion between the first end and the second end; and
enclosing the fluid channel and finishing the structure via deposition of the material to complete the suspension component.

2. The method of claim 1, wherein the suspension component is a knuckle, and
wherein the fluid channel is a hydraulic fluid line that transfers hydraulic fluid to a component of a brake assembly.

3. The method of claim 1, wherein the suspension component is a control arm, and
wherein the fluid channel is a hydraulic fluid reservoir that holds hydraulic fluid for use by a brake assembly.

4. The method of claim 1, wherein the fluid channel is a coolant fluid line delivering a coolant fluid through the suspension component to additional components of the vehicle.

5. The method of claim 1, wherein the material and the additional material are load carrying materials, and
wherein the load carrying materials include aluminum, steel, carbon fiber, and composite materials.

6. The method of claim 1, further comprising integrating one or more accessories along with the depositing of the additional material to form the fluid channel.

7. The method of claim 6, wherein the one or more accessories includes electrical wiring surrounded by an insulator.

8. The method of claim 6, wherein the one or more accessories includes one or more sensors to measure telemetry or environmental data of the suspension component.

9. The method of claim 6, wherein the one or more accessories includes a hydraulic bushing,
wherein the hydraulic bushing includes the fluid channel, and
wherein a damping coefficient of the hydraulic bushing changes responsive to hydraulic fluid passing through the fluid channel.

10. The method of claim 1, wherein the fluid channel has a variable diameter, and
wherein the variable diameter allows for accumulation of additional fluid within the base portion.

11. The method of claim 1, wherein positioning of the fluid channel within the suspension component is based on a shortest run length through the suspension component that maintains structural properties of the suspension component.

12. The method of claim 1, wherein the method is performed with an additive manufacturing technique utilizing multiple nozzles for different material types or various stages of the method.

13. A suspension assembly of a vehicle, the suspension assembly comprising:
a main hydraulic fluid reservoir operably coupled to the vehicle to hold hydraulic brake fluid;
a brake assembly operably coupled to a wheel assembly to use the hydraulic brake fluid to slow the vehicle;
a knuckle operably coupling the wheel assembly to the vehicle, the knuckle further comprising:
a base portion comprising a first end and a second end; and
a fluid channel configured to transfer the hydraulic brake fluid from a fluid inlet to a fluid outlet,
wherein the fluid channel is disposed between the first end and the second end,
wherein the fluid channel is enclosed between the first end and the second end, and
wherein the fluid channel is a hydraulic fluid line that transfers the hydraulic brake fluid to a component of the brake assembly.

14. The suspension component of claim 13, wherein the suspension component is a knuckle, and
wherein the fluid channel is a hydraulic fluid line that transfers hydraulic fluid to a component of a brake assembly.

15. The suspension component of claim 13, wherein the suspension component is a control arm, and
wherein the fluid channel is a hydraulic fluid reservoir that holds hydraulic fluid for use by a brake assembly.

16. The suspension component of claim 13, wherein the fluid channel is a coolant fluid line delivering a coolant fluid through the suspension component to additional components of the vehicle.

17. The suspension component of claim 13, wherein the suspension component and the fluid channel are formed of a load carrying material,
wherein the load carrying material is aluminum, steel, carbon fiber, or composite materials.

18. The suspension component of claim 13, wherein suspension component includes one or more accessories integrated with the fluid channel.

19. The suspension component of claim 13, wherein the fluid channel has a variable diameter between an inlet of the fluid channel and an outlet of the fluid channel,
wherein the variable diameter is independent of a shape of a body of the knuckle, and
wherein the variable diameter allows for accumulation of additional fluid within the base portion.

20. The suspension component of claim 21, wherein positioning of the fluid channel within the suspension component is based on a shortest run length through the suspension component optimizing structural properties of the suspension component.

21. The suspension assembly of claim 13, wherein an inlet of the fluid channel fluidly operably couples the main hydraulic fluid reservoir to the fluid channel,
wherein an outlet of the fluid channel fluidly operably couples the fluid channel to the component of the brake assembly, and
wherein the inlet and the outlet are disposed on the same side of the knuckle.

22. A suspension assembly of a vehicle, the suspension assembly comprising:
a main hydraulic fluid reservoir operably coupled to the vehicle to hold hydraulic brake fluid;
a brake assembly operably coupled to a wheel assembly to use the hydraulic brake fluid to slow the vehicle;
a control arm operably coupling the wheel assembly to the vehicle, the control arm further comprising:
a base portion comprising a first end and a second end; and
a fluid channel configured to transfer the hydraulic brake fluid from a fluid inlet to a fluid outlet,
wherein the fluid channel is disposed and enclosed between the first end and the second end, and
wherein the fluid channel is a secondary hydraulic fluid reservoir that holds the hydraulic brake fluid for use by the brake assembly.

23. The suspension assembly of claim 13, wherein an inlet of the fluid channel fluidly operably couples the main hydraulic fluid reservoir to the fluid channel,
wherein an outlet of the fluid channel fluidly operably couples the fluid channel to the component of the brake assembly,
wherein the inlet is disposed on a first lateral side of the control arm proximate to a longitudinal centerline of the vehicle, and
wherein the outlet is disposed on a second lateral side of the control arm opposite the first lateral side.

24. A suspension assembly of a vehicle, the suspension assembly comprising:
a main hydraulic fluid reservoir operably coupled to the vehicle to hold fluid;
a brake assembly operably coupled to a wheel assembly to use the fluid;
a suspension component operably coupling the wheel assembly to the vehicle, the suspension component further comprising:
a base portion comprising a first end and a second end; and
a fluid channel configured to transfer the fluid from a fluid inlet to a fluid outlet,
wherein the fluid channel is disposed and enclosed between the first end and the second end,
wherein the fluid channel is a secondary hydraulic fluid reservoir that holds the hydraulic brake fluid for use by the brake assembly,
wherein the suspension component includes a constant width and a constant height between the fluid inlet and the fluid outlet, and
wherein the fluid channel has a variable diameter between the fluid inlet and the fluid outlet to allow for accumulation of the hydraulic brake fluid within the base portion.

25. The suspension component of claim 18, wherein the one or more accessories includes electrical wiring surrounded by an insulator on a wall of the fluid channel.

26. The method of claim 18, wherein the one or more accessories includes one or more sensors integrated within the fluid channel to measure telemetry or environmental data of the suspension component.

27. The method of claim 18, wherein the one or more accessories includes a hydraulic bushing integrated with the fluid channel, and
wherein a damping coefficient of the hydraulic bushing changes responsive to hydraulic fluid passing through the fluid channel
